(19) United States
(12) Patent Application Publication
(10) Pub. No.: US 2002/0113443 A1
(43) Pub. Date: Aug. 22, 2002

(54) Positive locking mechanism with single action unlocking

(76) Inventor: Richard L. Sipley, Tallmadge, OH (US)

Correspondence Address: Richard L. Sipley, 619 Northeast Avenue, Tallmadge, OH, 44278, US

(21) Appl. No.: 09/792,389

(22) Filed: Feb. 22, 2001

(51) Int. Cl. E05C 19/10

(52) U.S. Cl. 292/126

(57) ABSTRACT

A locking mechanism for a self-dumping skid mounted container having a catch pin is disclosed and claimed. When the locking mechanism is unlocked the container dumps itself. When the locking mechanism is locked the container may be filled with material, usually scrap steel. A safety latch which engages the catch pin ensures that the container is not accidentally dumped. The catch pin is secured in the locked position by a catch pin hook, a pin support and locator and the safety latch. A spring is operable between the safety latch and the skid which ensures that the safety latch remains engaged. The safety latch is pivotally connected to the catch pin hook and wedgingly acts against the skid to rotate the catch pin hook out of the path of the catch pin allowing the container to self-dump.

### FIELD OF THE INVENTION

This invention is in the field of locking mechanisms for self-dumping skid mounted containers having a catch pin.

### BACKGROUND OF THE INVENTION

Self-dumping skid mounted containers made by Roura Iron Works have been used for many years. Locking mechanisms prevent self-dumping of the containers when locked and permit self-dumping of the containers when unlocked. It is the unbalanced design of the containers which allow them to dump by virtue of their own weight. Gear-like teeth on the containers interengage apertures in the skid mounted frame which guide and restrain the container as it dumps its load. After the load has been dumped, the container rocks back into position where it is capable of being locked again. When fully loaded these containers have the capacity to hold thousands of pounds of material. If the locking mechanism is accidentally or prematurely unlocked, the container will self-dump spewing thousands of pounds of material possibly causing loss of limb or life. Such skid mounted containers are usually moved with tow motors making an accidental dump even worse as the container is then elevated several feet off the ground.

Prior art locking mechanisms employ a safety latch whose design is supposed to prevent the upward motion of the handle of the locking mechanism. The safety latch of the prior art pivots about the handle of the locking mechanism and comprises a rectangular plate. To unlock the handle and permit self-dumping an operator must extend his or her arm and fingers to move the safety latch thus endangering themselves as it is possible for accidental injury to the operator's hands and/or arms if the handle does not hold the catch pin of the container in position. After the safety latch (rectangular blocking plate) has been rotated out of its blocking position, the operator must lift the handle upwardly to release the catch. Another deficiency of the prior art is that the safety latch does not always remain in the proper position due to vibration or an absent minded operator (forgetting to position the safety latch) thus raising the chance of an accident.

A need therefore, exists, for a positive locking mechanism which is releasable through a single action of the operator.

### SUMMARY OF THE INVENTION

The invention is a locking mechanism for a self-dumping skid mounted container having a catch pin. When the locking mechanism is unlocked the container dumps itself. When the locking mechanism is locked the container may be filled with material. The invention is a positive locking mechanism which is releasable through a single action of the operator.

A spring is operable between a pin affixed to a rotatable safety latch and the skid. The safety latch is rotatable relative to the catch pin hook. When the catch pin of the container is locked and the container is secured to the skid, the catch pin is restrained form movement by the catch pin support and locator, the catch hook and the safety latch. Unlocking of the catch pin is accomplished in a single motion of lifting the safety latch against the force of the spring and rotating it until it engages a side plate. A cam surface is formed by the top of the side plate and a flattened portion of the safety latch is the cam.

As the operator continues lifting the safety latch upwardly, the cam follower of the safety latch slides along the cam and wedges against the cam. Since the safety latch is pivotally connected to the catch pin hook, the catch pin hook rotates about its pivotal connection with the side plate and the catch pin support and locator sufficiently moving the catch pin hook out of engagement with the catch pin permitting self-dumping of the container. Subsequent to the dumping of the container the catch pin of the container engages the catch pin hook causing rotation of the catch pin hook from the closed position to the open position allowing the catch pin to engage the safety latch rotating the safety latch relative to the catch pin hook against the resilient tension of the spring. The spring in combination with the weight of the safety latch and the catch pin hook urge the catch pin hook into the closed position trapping the catch pin between the safety latch, the catch pin support and locator and the catch pin hook locking the container into the locked position for the reception of material.

Accordingly, it is an object of the present invention to provide a positive locking mechanism which is releasable and unlockable through a single action by the operator.

It is a further object of the present invention to provide a positive locking mechanism which is unlocked by a safety latch having a cam follower which engages a cam located on a plate. The safety latch slidingly and wedgingly engages the plate and pries the catch pin hook loose from interengagement with the catch pin.

It is a further object of the present invention to provide a positive latch which is coupled to the frame by a spring which assists in the rotation of the catch pin hook and the safety latch into their locked positions.

It is a further object of the present invention to provide a positive locking mechanism which restrains the catch pin of a container from three places: a safety latch; a catch pin hook and a catch pin support and locator.

It is a further object of the present invention to provide a positive locking mechanism which includes a safety latch and a catch pin hook with each having an open and closed position.

Other objects of the invention will be understood when references is made to the Brief Description of the Drawings, the Description of the Invention and the claims which follow hereinbelow.

### BRIEF DESCRIPTION OF THE DRAWINGS

FIG. 1 is a front view of the locking mechanism of the invention illustrating the catch pin engaging the safety latch, catch pin hook and the catch pin support and locator.

FIG. 2 is a rear view of the locking mechanism corresponding to the locked position illustrated in FIG. 1.

FIG. 3 is a front view of the locking mechanism with the safety latch released engaging the cam on the top shelf of the plate.

FIG. 4 is a rear view of the locking mechanism corresponding to the view illustrated in FIG. 3.

FIG. 5 is a front view of the locking mechanism in the unlocked position illustrating the wedging action of the cam follower of the safety latch against the cam of the plate.

FIG. 6 is a rear view of the locking mechanism corresponding to the view illustrated in FIG. 5.

FIG. 7 is a right side view of the locking mechanism corresponding to the view in FIG. 3.

FIG. 8 is a right side view of the locking mechanism corresponding to the view in FIG. 5.

FIG. 9 is a perspective view of the environment of the locking mechanism illustrated together with the skid mounted self-dumping container.

FIG. 10 is an enlarged front view of the safety latch.

FIG. 11 is an enlarged front view of the catch pin hook.

FIG. 12 is a front view of a prior art locking mechanism.

A better understanding of the invention will be had when reference is made to the Description of the Invention and claims which follow herein below.

### DESCRIPTION OF THE INVENTION

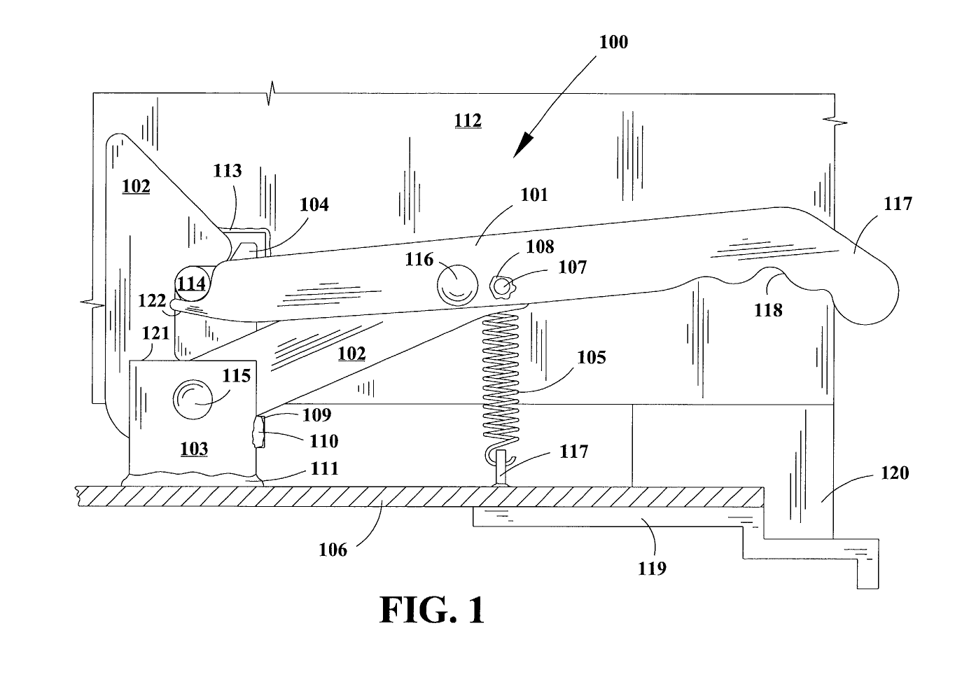

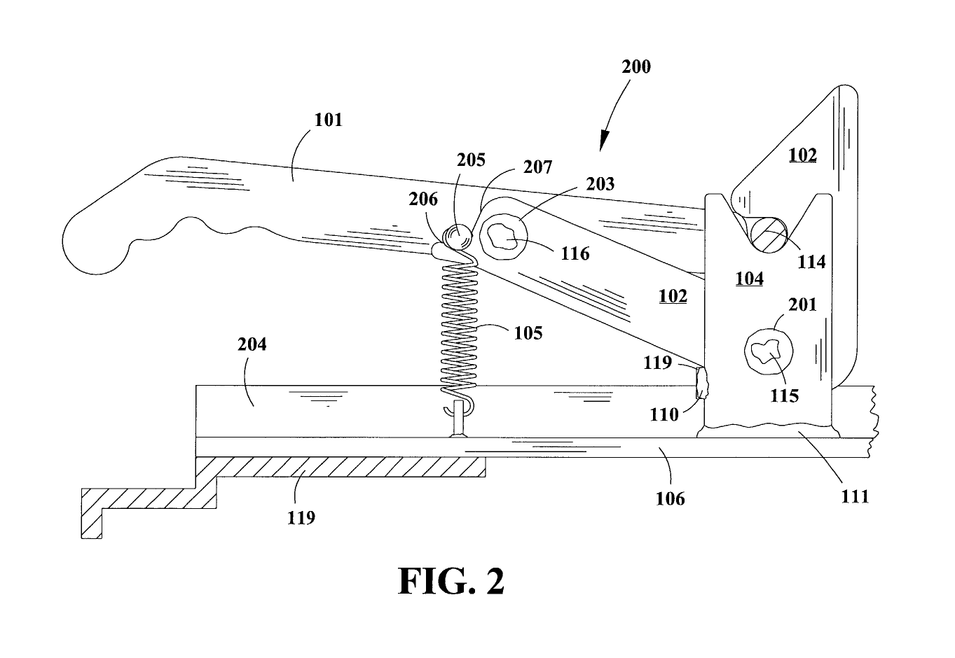

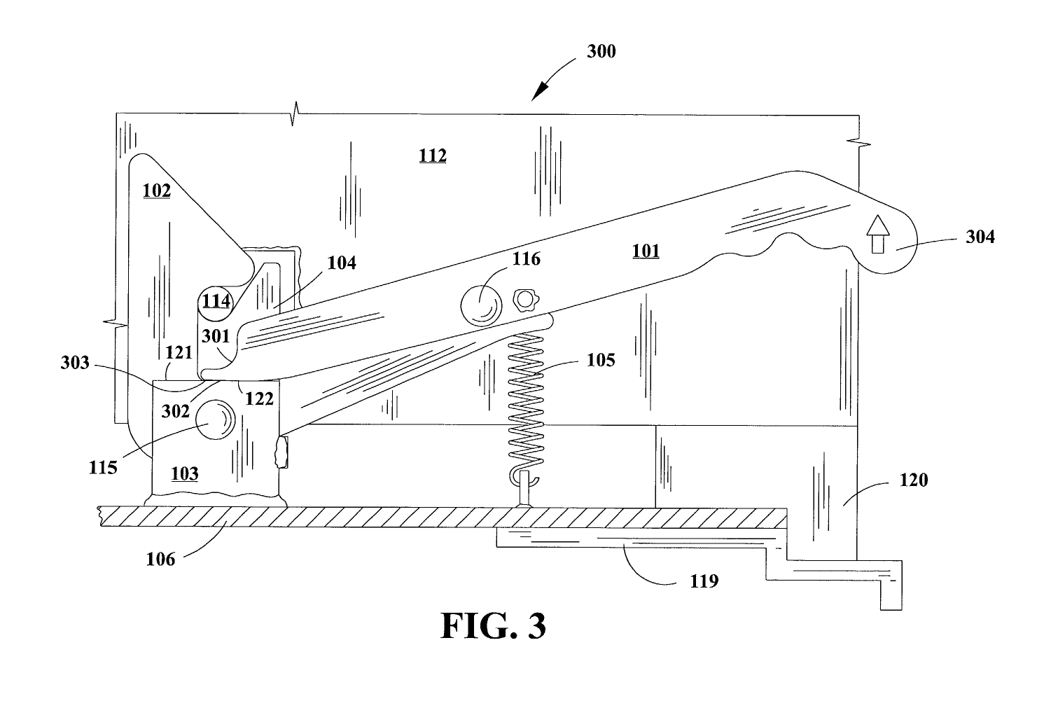

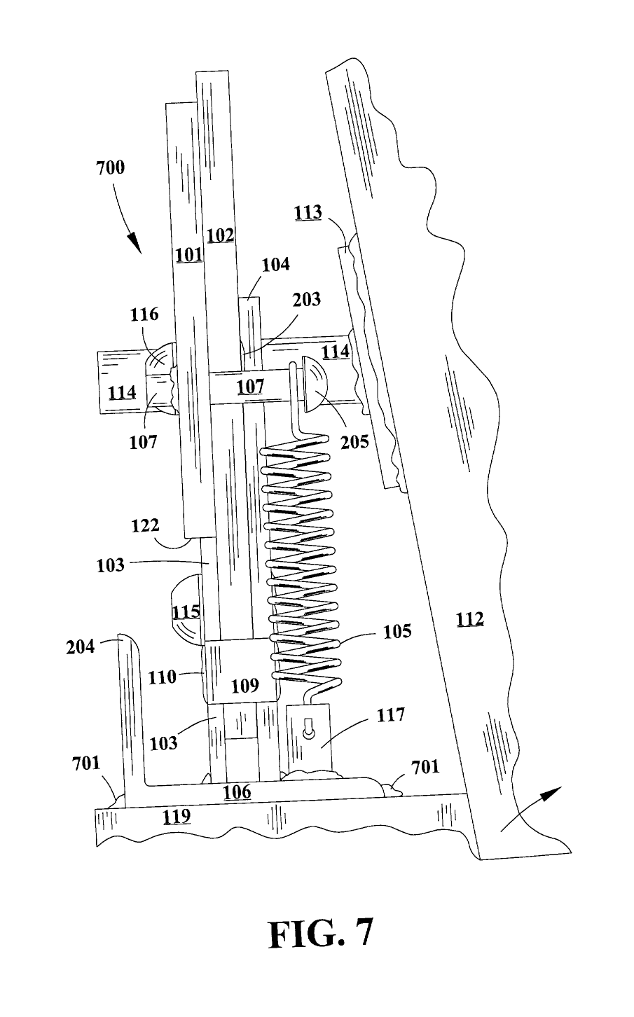

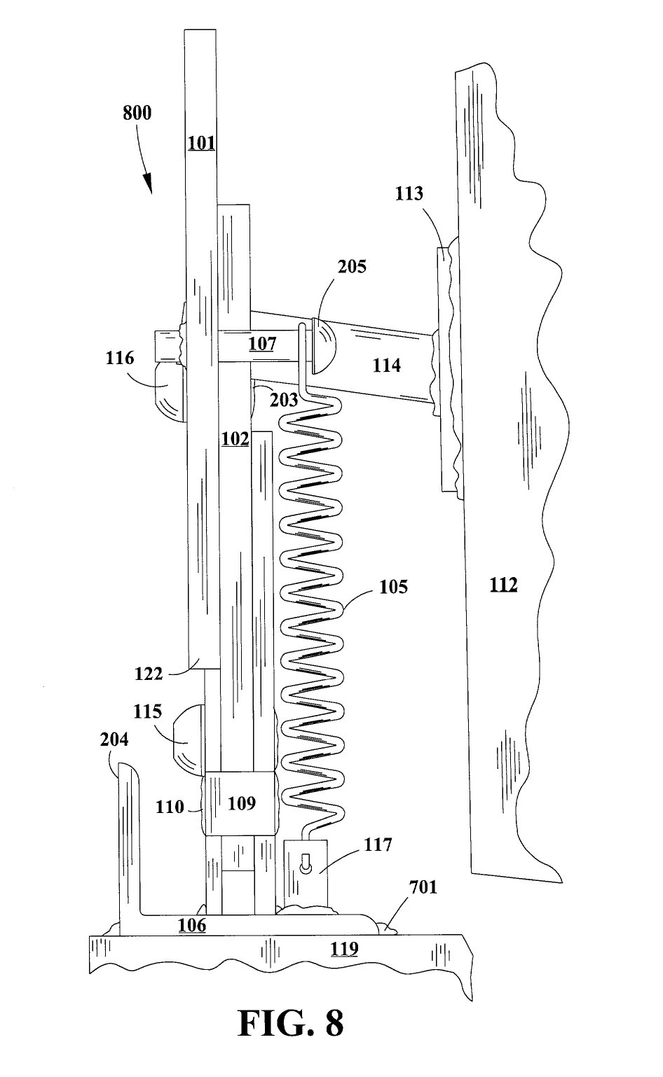

FIG. 1 is a front view of the locking mechanism 100 of the instant invention illustrating the catch pin 114 engaging the safety latch 101, catch pin hook 102 and the catch pin support and locator 104. Side plate 103 is welded 111 to angle 106 which is shown in cross section. Rivet 115 extends through side plate 103, catch pin hook 102 and the catch pin support and locator 104. See, FIGS. 7 and 8. Rivet 115 is welded to catch pin support and locator 104. See, FIG. 2 wherein the welding is indicated with reference numeral 201. Safety latch 101 is an elongated bar pivotally connected to the catch pin hook by a rivet 116. As shown in FIG. 1 safety latch 101 is in the closed position. The left most portion of safety latch 101 illustrates the engagement of the safety latch with the catch pin 114. FIG. 1 also illustrates the catch pin hook 102 engaging the catch pin 114. FIG. 3 illustrates the curvilinear surface 301 which engages the catch pin 114 when latch 101 is in the closed, locked position as shown in FIG. 1.

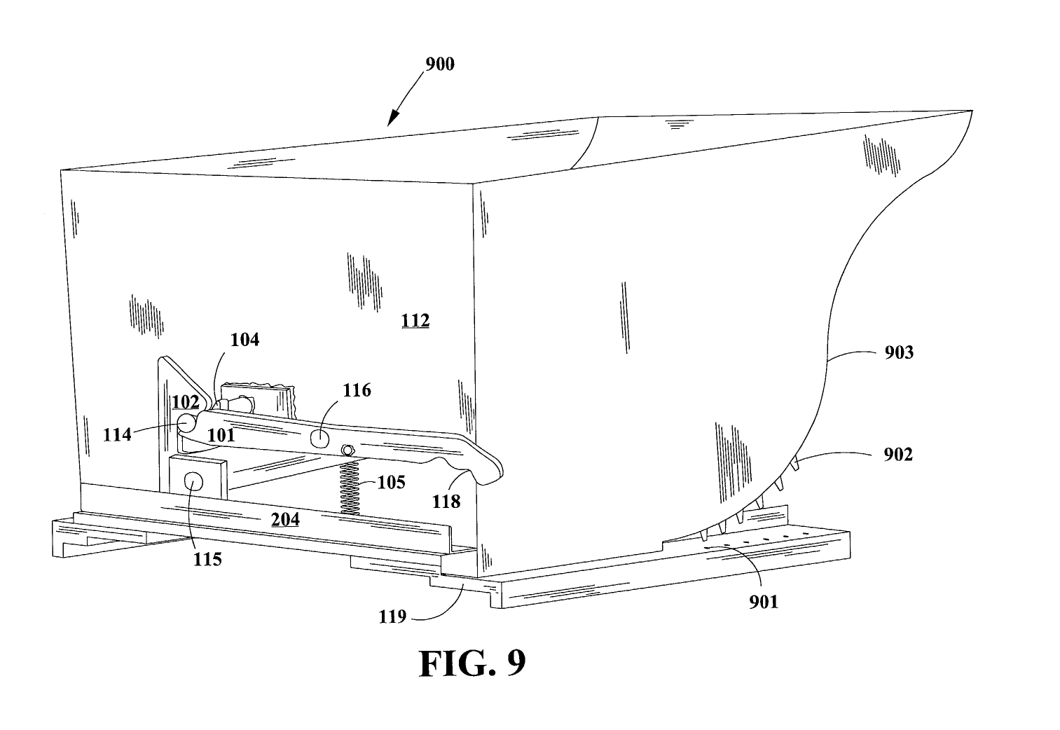

Side plate 103 includes a cam surface 121. Side plate 103 is rectangular plate. Safety latch 101 includes a cam follower 122 for sliding engagement with cam 121. Catch pin 114 is mounted on plate 113 which in turn is welded to container 112. Container 112 is illustrated in FIG. 9. FIG. 9 is a perspective view of the environment of the locking mechanism illustrated together with the skid mounted self-dumping container 112.

Referring to FIG. 1 again, spring 105 is operable between spring latch 117 and pin 107. Pin 107 is best viewed in FIGS. 7 and 8. Pin 107 is welded to and passes through safety latch 101.

Still referring to FIG. 1 stop 109 prevents catch pin hook 102 from rotating beyond its closed position as shown in FIG. 1. Stop 109 is welded 110 to plate 103 and catch pin support and locator 104. Catch pin hook 102 and safety latch 101 are illustrated in their closed positions in FIG. 1. Safety latch 101 pivots about rivet 116. Rivet 116 extends through safety latch 101 and catch pin hook 102. Rivet 116 is affixed by a weld to catch pin hook 102.

Still referring to FIG. 1, safety latch 101 has an extended portion 117 with a grip portion 118. The grip portion enables the operator to grasp the handle and unlock the locking mechanism. Container 112 includes feet 120 resting upon frame 119. Sometimes the frame 119 is referred to as a skid.

Referring again to FIG. 9, frame 119 and one of the feet 120 are shown. Frame 119 includes apertures 901 which interengage gear-like teeth 902. These gear-like teeth 902 reside on a curvilinear surface 903 which enables the container 112 to self-dump when the latch mechanism 100 is unlocked. Reference numeral 900 illustrates generally the environment of the positive locking mechanism.

Referring again to FIG. 2 which is a rear view of the locking mechanism corresponding to the locked position illustrated in FIG. 1, reference numeral 200 generally signifies this view. Catch pin hook 102 includes a cut out 207 to allow pin 107 to rotate relative to catch pin hook 102. Pin 107 includes a head 205 best viewed in FIGS. 7 and 8. Spring 105 is hooked over pin 107. Catch pin hook 102 includes seat or stop 206 for the pin 107 to rest on when the safety latch 101 is in its closed or locked position and when the catch pin hook 102 is in its closed or locked position. FIG. 2 illustrates the welding 203 of the rivet 116 to the catch pin hook.

Catch pin 114 is illustrated in cross section and from this view catch pin 114 is restrained by catch pin hook 102, catch pin support and locator 104 and safety latch 101. It is the tension of the spring 105 which urges the pin 107 against stop 206 on catch pin hook 102 thus insuring that catch pin hook 102 is not accidentally opened or unhooked. Also viewed in FIG. 2 is the upward portion 204 of the angle iron 106 not shown in FIG. 1.

FIG. 3 is a front view of the locking mechanism with the safety latch 101 released and engaging the cam 121 on the top shelf of plate 103. Reference numeral 300 generally indicates the safety latch released against the force of spring 105. Spring 105 is slightly elongated as viewed in FIG. 3. Arrow 304 illustrates the upward movement of safety latch 101. Safety latch 101 includes a curvilinear surface 301 which engages catch pin 114 when said safety latch is in the closed position as shown in FIG. 1. Cam follower 122 is also illustrated in FIG. 3 and reference numeral 302 is meant to illustrate the cam action between the cam 121 and cam follower 122. Reference numeral 303 indicates the leftward position of cam follower 122 as the safety latch 101 is rotated from the closed position to the intermediate position shown in FIG. 3.

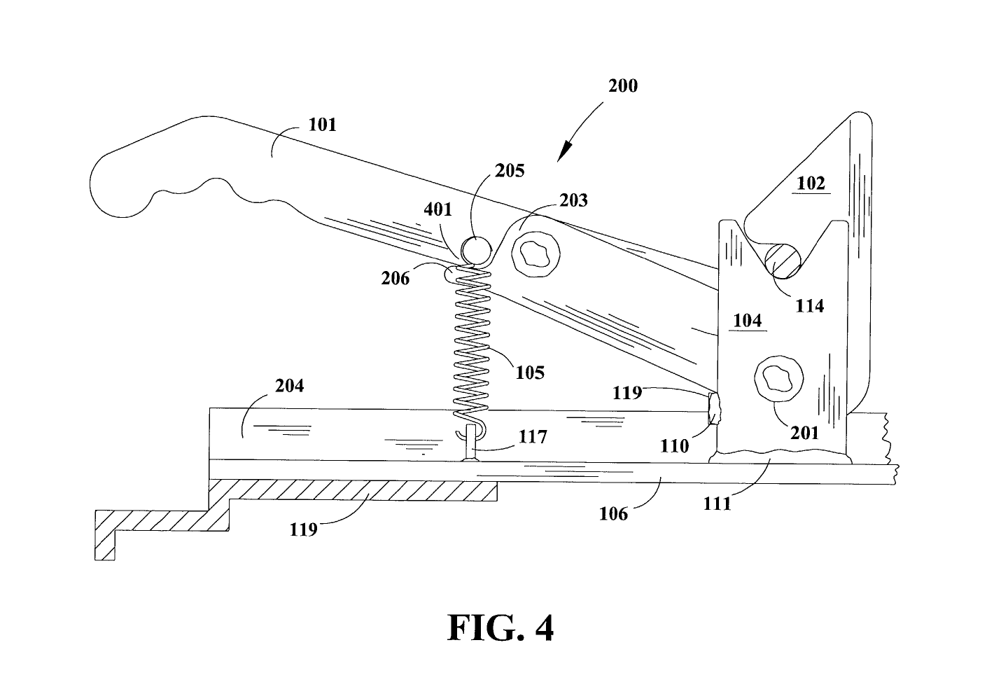

FIG. 4 is a rear view of the locking mechanism corresponding to the view illustrated in FIG. 3. Reference numeral 400 generally indicates the rear view of the safety latch 101 released against the force of spring 105. Reference numeral 401 indicates a gap between the pin 107 and seat 206 of catch pin hook 102. Pin 107 is slightly space apart from the seat 206 of the catch pin hook 102 when the safety latch is released.

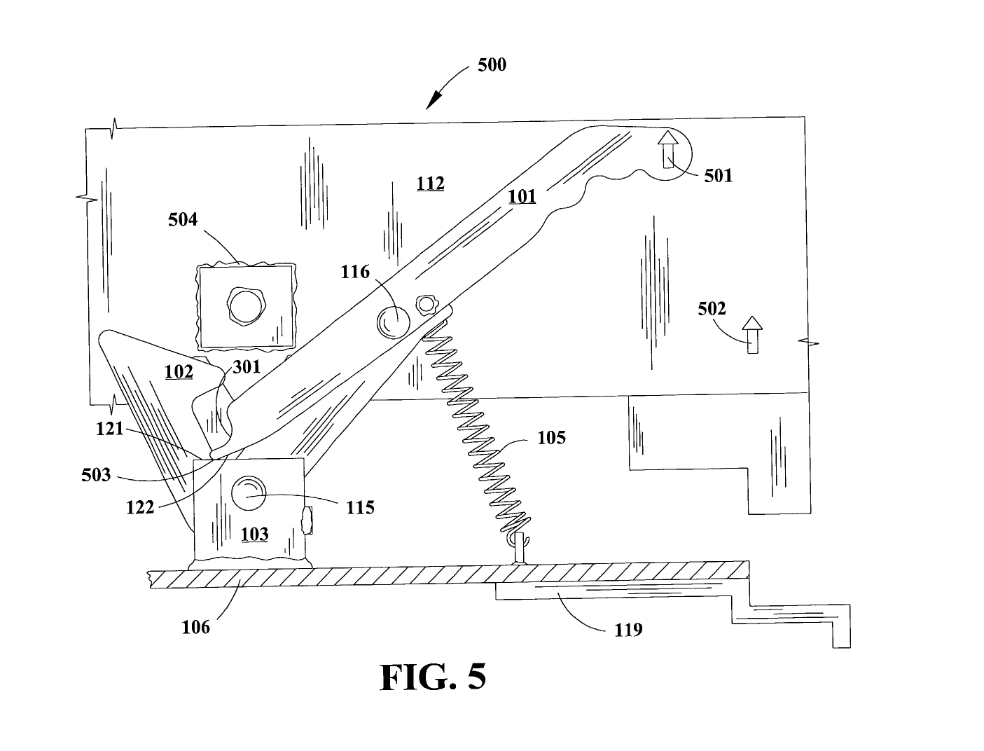

FIG. 5 is a front view of the locking mechanism in the unlocked position or the open position illustrating the wedging action of the cam follower 122 of the safety latch 101 against the cam 121 of the plate 103. Reference numeral 500 indicates the open, unlocked position of the safety latch 101 and the catch pin hook 102. Arrow 501 indicates the upward movement of the safety latch 101 and arrow 502 indicates the upward rotational movement of container 112. Reference numeral 503 indicates the leftward extent of the cam follower 122 with respect to the cam 121. Reference numeral 504 is the weld of plate 113 to hopper or container 112.

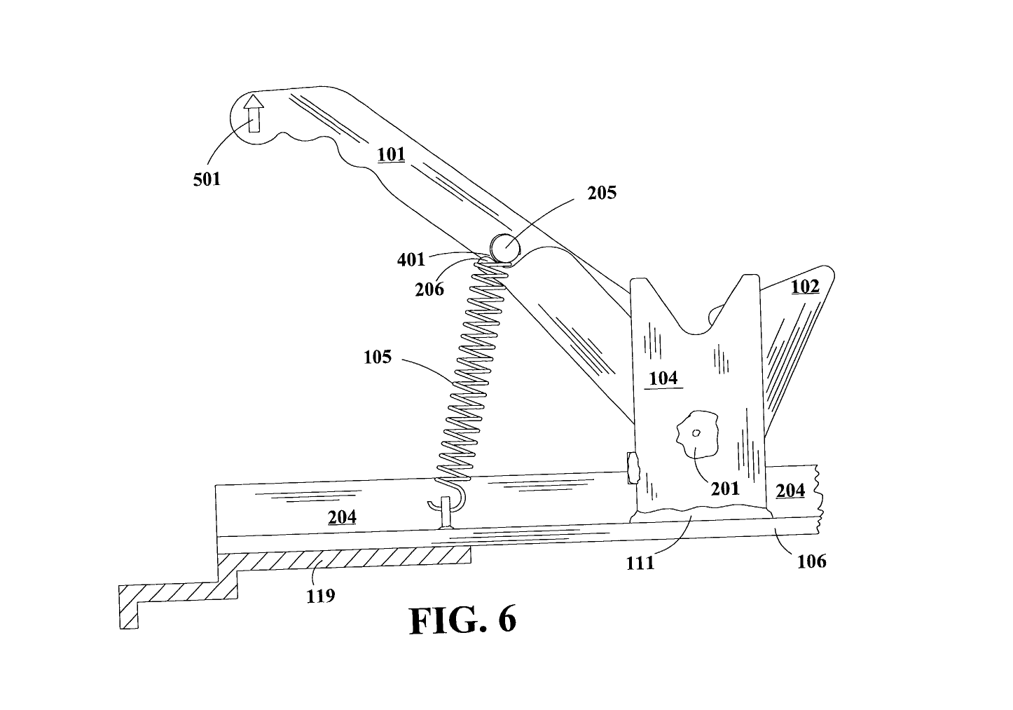

Referring to FIG. 6, a rear view of the locking mechanism corresponding to the view illustrated in FIG. 5, the elongation of spring 105 can be viewed. The same approximate gap 401 between the stop 206 and the pin 107 is maintained through the rotation of the safety latch.

FIG. 7 is a right side view of the locking mechanism corresponding to the view shown in FIG. 3, the beginning or intermediate stage of opening. Reference numeral 700 generally designates the right side view corresponding to FIG. 3. As viewed in FIG. 7 spring 105 is slightly elongated. It will be understood by those skilled in the art that the respective figures as illustrated in herein are not to scale but rather for illustration purposes. Scale from one drawing to the next also varies. Pin 107 is shown welded to safety latch 101 and cap or head 205 is best viewed in this drawing. Container 112 is shown at an angle with respect to frame 119 in this view and in this view while still locked pin 114 is shown parallel to frame 119. Reference numeral 701 is used to designate the weld of the angle iron 106 to the frame 119.

FIG. 8 is a right side view of the locking mechanism corresponding the view in FIG. 5, the open position of the safety latch 101 and the catch pin hook 102. Catch pin 114 is shown as the container 112 is rotating upward and rightwardly with respect to its initial position. Reference numeral 800 generally indicates the right side view corresponding to FIG. 5 illustrating the container raised and rotated away from its seated position.

FIG. 9 is a perspective view of the environment of the locking mechanism illustrated together with the skid mounted self-dumping container. When the locking mechanism is released the container released as illustrated in FIG. 5, the container 112 rolls rightwardly and downwardly to dump its contents. Typically a towmotor's forks slidingly engage the frame 119 and raise the frame and container upwardly several feet into the air. When the container is unlocked and dumped the operator raises the grip portion 118 of the safety latch or handle 101 unlocking the mechanism and wedgingly engaging cam 121. Cam 122 on safety latch 101 is also illustrated.

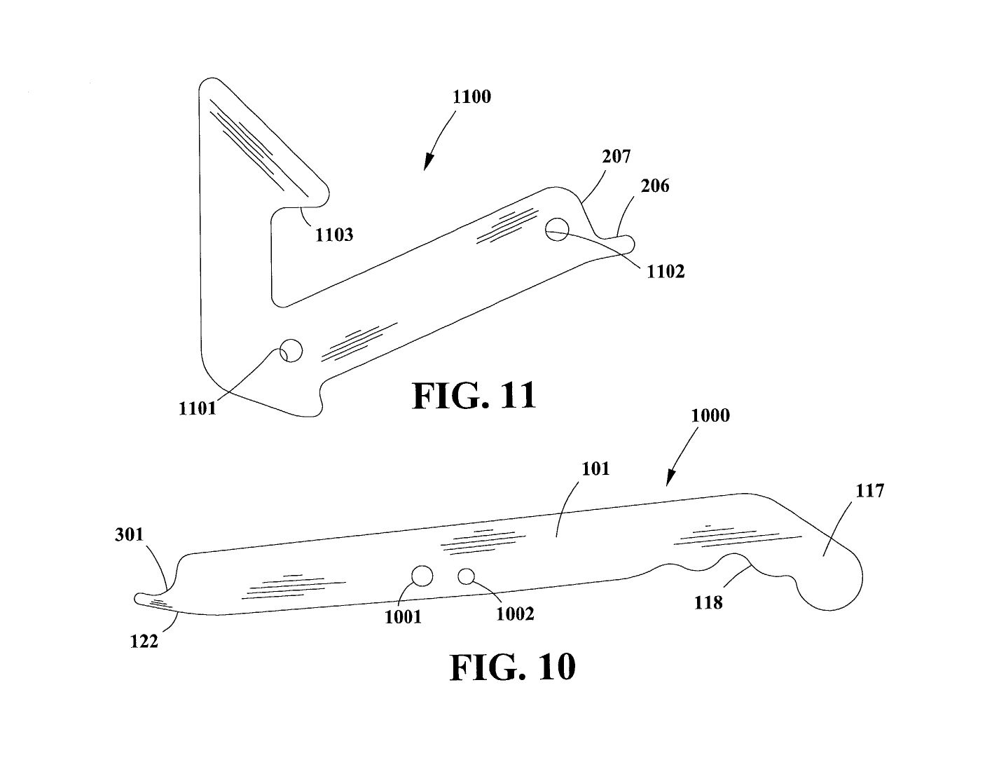

FIG. 10 is an enlarged front view of the safety latch 101. Reference numeral 1000 indicates the safety latch and handle. Aperture 1001 is for the rivet 116 and aperture 1002 is the aperture in which the pin 107 resides.

FIG. 11 is an enlarged front view of the catch pin hook 102. Reference numeral 1100 illustrates the truncated hook employed in this invention. Aperture 1101 allows for the passage of rivet 115 therethrough. Aperture 1102 allows for the passage of rivet 116 therethrough and reference numeral 1103 is the locking or engaging surface which abuts or engages catch pin 114.

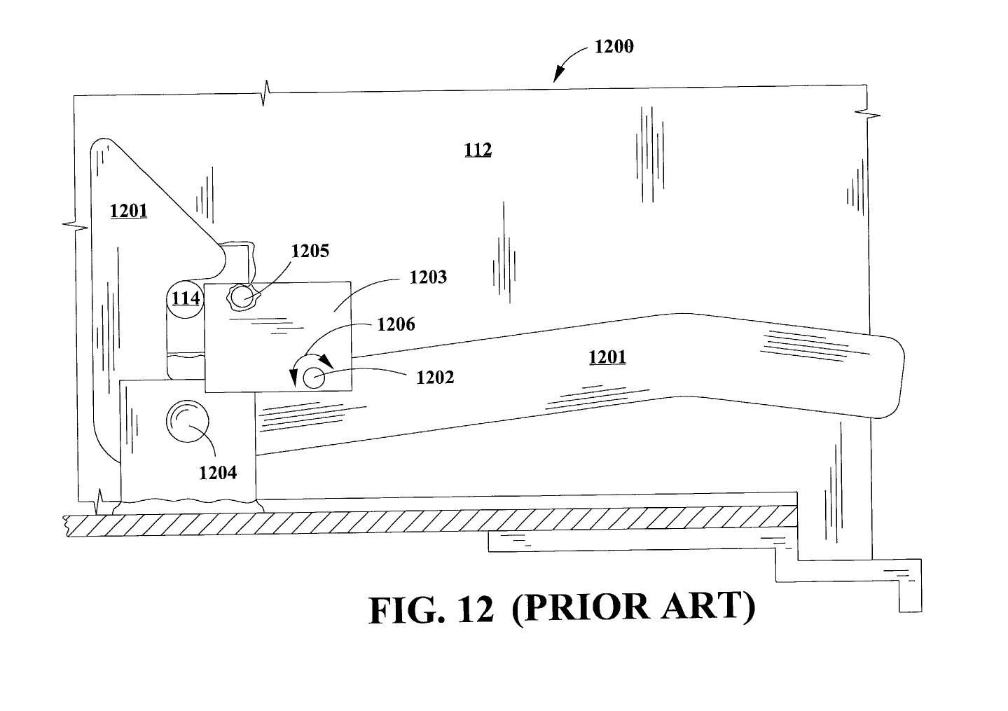

FIG. 12 is a front view of a prior art locking mechanism 1200 shown with locking plate 1203 in the locked position. Handle and hook 1201 are illustrated in FIG. 12. The instant invention employs a handle comprising a safety latch 101 and a catch pin hook 102. Locking plate 1203 pivots about a pivot pin 1202. As shown in FIG. 12 the locking plate 1203 engages pin 114 restraining its movement. A handle 1205 is affixed to the locking plate and it is this handle 1205 which the operator must grasp to rotate plate 1203 as indicated by rotational arrow 1206. To disengage and unlock the catch pin 114 the operator must first reach across the container 112 and handle 1205 and rotate the locking plate 1203 in a clockwise direction. He must then lift the handle 1201 and allow the escape of catch pin 114. To lock this prior art device the operator must rotate the locking plate 1203 in a counterclockwise direction as indicated by rotational arrow 1206. When the operator sticks his or her hand half the width of the skid to reach the locking plate 1203 it is usually in a relatively confined space which may lead to injury. The space is confined because a towmotor may be snugly up against the skid mounted container. Therefore, in the prior art device of FIG. 12 at least two steps are necessary to unlock the container and two steps are necessary to lock the container.

The present invention is a positive locking mechanism. The force of the spring 105 together with the combined weight of the safety latch 101 and the catch pin hook 102 rotate the catch pin hook 102 into engagement with the stop 109. Stop 109 is welded to plate 103 and catch pin support and locator 104. Catch pin support and locator 104 includes a V-shaped portion which guides and locates the catch pin 114 as it enters the latching mechanism. Container 112 rotates as it dumps. As container 112 wears, the gear-like teeth do not fit as tightly within the apertures in the skid and, as such, as the container rocks back toward the locked position of the catch pin 114 will not necessarily return to the same position every time. In other words, the container 112 may wobble as it rocks back to be locked.

During opening, the locking mechanism is pried to the open position as illustrated in FIG. 5. During opening the safety latch 101 is rotated counterclockwise with respect to said catch pin hook 102 and catch pin hook is rotated counterclockwise to the open, unlocked position. After the catch pin 114 is released, the handle/safety latch 101 is released and the tension in spring 104 urges the handle/safety latch 101 downwardly. Pin 107 engages shoulder 206 on catch pin hook 102 which in combination with rivet 116 urges catch pin hook 102 downwardly rotating said catch pin hook in a clockwise direction returning the locking mechanism to the position as shown in FIG. 1 only the catch pin 114 is absent therefrom.

When container 112 is rotated back after having been dumped, catch pin 114 engages the sloped surface on truncated catch pin hook 102. The weight of the container forces the catch pin hook to be rotated counterclockwise to its open position. As catch pin hook 102 rotates out of the way of catch pin 114 it is able to slip by the catch pin hook 102 and engages the top portion of safety latch 101 forcing it to rotate relative to the catch pin hook against the tension of the spring. As the catch pin 114 sufficiently engages the catch pin hook 102, the V-shaped portion of the catch pin support and locator guides the catch pin 114 into position. The bottom of the V-shaped portion limits the travel of the catch pin in a downward direction. Spring 105 together with the weight of the hook 102 and latch 101, lock pin 114 and securely within the grasp of the three point locking mechanism.

The preferred material of the locking mechanism is carbon steel. Welding is the preferred way of attaching the rivets to one or the other of its contact points. The spring constant of the spring employed is also a function of the size and weight of the components of the invention.

The invention has been described with particularity herein. Those skilled in the art will readily recognize that various changes and modifications may be made to the instant invention without departing from the spirit and scope of the appended claims.

I claim:

1. A locking mechanism for a skid mounted container having a catch pin comprising: a safety latch; a catch pin hook, and a catch pin support and locator.

2. A locking mechanism as claimed in claim 1 further comprising a side plate and a first rivet; said first rivet extending through said side plate, said catch pin hook and said catch pin support and locator; and, said rivet being affixed to said catch pin support and locator.

3. A locking mechanism as claimed in claim 2 further comprising a second rivet extending through said safety latch and said catch pin hook; and, said second rivet being affixed to said catch pin hook.

4. A locking mechanism as claimed in claim 3 further comprising: a pin affixed to said safety latch; and, a spring operable between said pin of said safety latch and said skid.

5. A locking mechanism for a container as claimed in claim 4: wherein said side plate and said catch pin support and locator are affixed to said skid; wherein said side plate includes a cam and said safety latch includes a cam follower; and, wherein upon release of said safety latch said safety latch pivots about said second rivet with said cam follower slidably engaging said side plate leveraging said catch pin hook from a closed position to an open position.

6. A locking mechanism as claimed in claim 1, wherein said catch pin support and locator includes a V-shaped portion therein.

7. A locking mechanism for a container having a catch pin comprising a safety latch; a catch pin hook; a catch pin support; said safety latch, said catch pin hook and said catch pin support engage said catch pin of said container.

9. A locking mechanism for a container having a locking pin as claimed in claim 7 further comprising a spring operable between said safety latch and said frame.

10. A locking mechanism for a container having a catch pin, said container being rotatably mounted on a frame such that said container is alternately filled with material and then dumped, said container being locked and unmoveable when filled with material, said container being rotatable and dumped when unlocked, said locking mechanism comprising: a plate and a catch pin support and locator; said plate and said catch pin support and locator being affixed to said frame; a catch pin hook pivotally mounted between said plate and said pin support and locator; a safety latch pivotally mounted to said catch pin hook; a spring operable between said frame and said safety latch; said catch pin support and locator, said hook and safety latch engage said catch pin of said container when said container is locked to said frame; said safety latch disengages said catch pin and engages said plate providing leverage for pivotally moving said catch pin hook from a closed position locking said container to an open position unlocking and dumping said container; and, said spring engages said safety latch urging said catch pin hook to return to said closed position after escape of said catch pin and dumping of said container.

11. A locking mechanism for a container having a catch pin as claimed in claim 10 wherein subsequent to said dumping of said container said catch pin of said container engages said catch pin hook causing rotation of said catch pin hook from said closed position to said open position allowing said catch pin to engage said safety latch rotating said safety latch relative to said catch pin hook against the resilient tension of said spring, and, said spring in combination with the weight of said safety latch and said catch pin hook urge said catch pin hook into closed position trapping said catch pin between said safety latch, said catch pin support and locator and said catch pin hook locking said container into locked position for the reception of material.

12. A locking mechanism for a container having a catch pin as claimed in claim 11 further comprising a stop affixed to said plate and said catch pin support and locator.

13. A locking mechanism for a self-dumping skid mounted container having a catch pin comprising: a safety latch having open and closed positions; a catch pin hook having open and closed positions; a catch pin support and locator; a plate; a first pivot extending through said catch pin hook and affixed to either said plate or said catch pin support and locator such that said catch pin hook is rotatable between closed and open positions; a second pivot affixed to either said catch pin hook or said safety latch such that said safety latch is rotatable between open and closed positions; a spring operable between said safety latch and said skid urging said safety latch and said catch pin hook to their second closed position; and, said safety latch slidingly and wedgingly engaging said plate urging said safety latch and said catch pin hook to their open positions.

14. A locking mechanism for a self-dumping skid mounted container having a catch pin as claimed in claim 13 wherein said plate includes a cam and said safety latch includes a cam follower.

15. A locking mechanism for a self-dumping skid mounted container having a catch pin as claimed in claim 14 wherein said safety latch includes a curvilinear surface for engaging said catch pin.

16. A locking mechanism for a self-dumping skid mounted container having a catch pin as claimed in claim 15 further comprising a pin affixed to said safety latch and wherein said catch pin hook includes a shoulder thereon, said pin of said safety latch engages said shoulder of said catch pin hook under the tension of said spring when said safety latch is in the closed position.

17. A locking mechanism for a self-dumping skid mounted container having a catch pin as claimed in claim 16 further comprising a stop affixed to said plate and said catch pin support and locator preventing rotation of said catch pin hook beyond said closed position of said hook.

18. A handle for a locking mechanism used to lock and unlock a self-dumping skid mounted container having a catch pin comprising: a catch pin hook pivotally mounted to said skid; a safety latch pivotally mounted to said catch pin hook; said safety latch includes a pin; a spring affixed to said pin and to said skid; said catch pin hook includes a shoulder thereon; said pin of said safety latch engages said shoulder of said catch pin hook under tension of said spring ensuring engagement of said safety latch with said catch pin locking said container to said skid; and, under external force applied to said safety latch: said spring is elongated separating said pin of said safety latch from said shoulder of said catch pin hook, and, said safety latch wedgingly acts against said skid unlocking said skid mounted container allowing said container to self-dump.

19. A handle as claimed in claim 18 wherein said safety latch includes a curvilinear surface for engaging said catch pin of said container and said safety latch also includes a cam follower surface for engaging a cam on said skid.

20. A handle as claimed in claim 19 wherein said safety latch rotates with respect to said catch pin hook and slidingly and wedgingly engages said skid.

21. A handle as claimed in claim 20 further including a stop limiting the rotational movement of said catch pin hook.
